(19) United States
(12) Patent Application Publication
(10) Pub. No.: US 2018/0088891 A1
(43) Pub. Date: Mar. 29, 2018

(54) DISPLAY METHOD, DISPLAY APPARATUS AND DRIVING RECORDER

(71) Applicant: Beijing Xiaomi Mobile Software Co., Ltd., Beijing (CN)

(72) Inventors: Yue CHENG, Beijing (CN); Yan XIE, Beijing (CN); Qiqi CUI, Beijing (CN)

(21) Appl. No.: 15/708,141

(22) Filed: Sep. 19, 2017

(30) Foreign Application Priority Data
Sep. 28, 2016 (CN) PCT/CN2016/100544

(51) Int. Cl. G06F 3/14; G06F 3/147; G06F 3/0488; H04M 1/725

(52) U.S. Cl. CPC G06F 3/1454; H04M 1/72527; G06F 3/04883; G06F 3/147

(57) ABSTRACT

The present application provides a display method, a display apparatus and a driving recorder, which relates to the field of communication technology. The method for use in a driving recorder includes: establishing a communication connection between the driving recorder a terminal device; receiving interface data sent from the terminal device through the communication connection; displaying the terminal interface in a display screen of the driving recorder according to the interface data; receiving a control signal applied to the driving recorder; and controlling the terminal device according to the control signal. The present disclosure solves a problem of high safety risk caused from a user operating his/her mobile phone when he or she is driving. Since the user may directly view the message of the terminal device in the display screen of the driving recorder and perform appropriate operations during the driving process, without operating the terminal device, safety of driving is improved.

### CROSS-REFERENCE TO RELATED APPLICATIONS

The present application is based upon and claims priority to International Application No. PCT/CN2016/100544, filed Sep. 28, 2016, the entire contents of which are incorporated herein by reference.

### TECHNICAL FIELD

The present disclosure generally relates to the field of communication technology, and more particularly, to a display method, a display apparatus and a driving recorder.

### BACKGROUND

With the development of economy, the popularity of cars gradually increases, and driving safety has also been paid more and more attention to.

A user may need to perform dialing, answering a call, viewing messages and other operations on his/her mobile phone when he/she is driving a car. For example, when the mobile phone used by the user has an incoming call, the user needs to answer the call, so he or she needs to look for his/her mobile phone for answering at that time, which causes high safety risk.

### SUMMARY

In order to solve problems of high safety risk caused by a user operating his/her mobile phone in the process of driving, the present disclosure provides a display method, a display apparatus and a driving recorder. The technical solution is as follows.

According to a first aspect, there is provided a display method for use in a driving recorder, including:

establishing a communication connection between the driving recorder and a terminal device;

receiving interface data sent from the terminal device through the communication connection, wherein the interface data is data of a terminal interface displayed by the terminal device in real time;

displaying the terminal interface in a display screen of the driving recorder according to the interface data;

receiving a control signal applied to the driving recorder, wherein the control signal is for controlling the terminal device; and

controlling the terminal device according to the control signal.

According to a second aspect, there is provided a display apparatus for use in a driving recorder, including:

a processor; and

a memory for storing instructions executable by the processor,

wherein the processor is configured to:

establish a communication connection between the driving recorder and a terminal device;

receive interface data sent from the terminal device through the communication connection, wherein the interface data is data of a terminal interface displayed by the terminal device in real time;

display the terminal interface in a display screen of the driving recorder according to the interface data;

receive a control signal applied to the driving recorder, wherein the control signal is for controlling the terminal device; and

control the terminal device according to the control signal.

According to a third aspect, there is provided a driving recorder, including: a display screen, a processor and a memory for storing instructions executable by the processor, wherein the display screen is electrically connected to the processor, and the processor is configured to perform the above display method according to the first aspect.

The technical scheme according to embodiments of the present disclosure may have the following beneficial effects.

After the driving recorder establishes a communication connection with a terminal device, interface data of the terminal device is received through the communication connection and displayed, thus displaying the terminal interface of the terminal device in a display screen of the driving recorder. The driving recorder may further receive a control operation and control the terminal device according to the control operation. Through the present disclosure, it solves a problem of high safety risk caused from a user operating his/her mobile phone when he or she is driving. Since the user may directly view the message of the terminal device in the display screen of the driving recorder and perform appropriate operations during the driving process, without operating the terminal device, safety of driving is improved.

It is to be understood that both the foregoing general description and the following detailed description are exemplary only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram of an implementing environment involved in various embodiments of the present disclosure;

FIG. 2 is a flow chart of a display method provided by an exemplary embodiment of the present disclosure;

FIG. 3 is a flow chart of a display method provided by another exemplary embodiment of the present disclosure;

FIG. 4 is a schematic diagram of the displaying involved in an exemplary embodiment of the present disclosure;

FIG. 5 is a flow chart of a display method provided by another exemplary embodiment of the present disclosure;

FIG. 6 is a flow chart of a display method provided by another exemplary embodiment of the present disclosure;

FIG. 7A is a schematic diagram of the displaying involved in another exemplary embodiment of the present disclosure;

FIG. 7B is a schematic diagram of the displaying involved in another exemplary embodiment of the present disclosure;

FIG. 8 is a schematic diagram of the displaying involved in another exemplary embodiment of the present disclosure;

FIG. 9 is a schematic diagram of the displaying involved in another exemplary embodiment of the present disclosure;

FIG. 10 is a schematic diagram of the displaying involved in another exemplary embodiment of the present disclosure;

FIG. 11 is a block diagram of a display apparatus provided by an exemplary embodiment of the present disclosure;

FIG. 12 is a block diagram of a display apparatus provided by another exemplary embodiment of the present disclosure;

FIG. 13 is a block diagram of a display apparatus provided by another exemplary embodiment of the present disclosure; and

FIG. 14 is a structural schematic diagram of a driving recorder provided by another exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

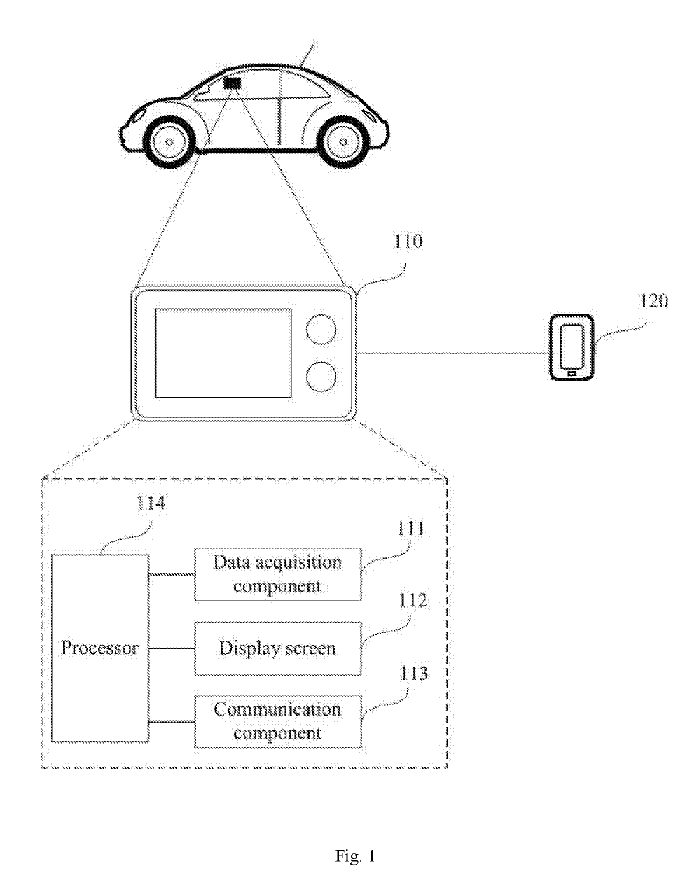

FIG. 1 is a schematic diagram of an implementing environment involved in various embodiments of the present disclosure. The implementing environment may include a driving recorder 110 and a terminal device 120.

Usually, the driving recorder 110 is installed in a vehicle, and the driving recorder 110 generally includes a data acquisition module 111 such as a camera and a microphone, or the like. The data acquisition unit 111 is used for acquiring driving data such as images and sounds during driving. Optionally, the driving recorder 110 further includes a display screen 112 for displaying the acquired driving data in real time. Optionally, the display screen 112 in the driving recorder 110 is a touch display screen. The driving recorder 110 is further used to receive and respond to touch operations applied to the touch display screen.

Optionally, the driving recorder 110 further includes a communication component 113. The driving recorder 110 establishes a communication connection with the terminal device 120 through the communication component 113 and transmits data. Optionally, the communication component 113 in the driving recorder 110 is a wireless communication component and/or a hardware communication interface. Optionally, the wireless communication component includes at least one of a WiFi (Wireless-Fidelity) module, a Bluetooth module, a NFC (Near Field Communication) module and a Zigbee (Zigzag Flying of Bees) module. Optionally, the hardware communication interface includes at least one of a USB (Universal Serial Bus) type A interface, a USB type B interface, a Mini USB type A interface, a Mini USB type B interface, a Mini USB AB type interface, a Micro USB type Interface, a Micro USB Type B interface, a USB Type-C interface and a Lightning interface.

Optionally, the driving recorder 110 further includes a processor 114. Each of the data acquisition component 111, the display screen 112, and the communication component 113 is connected to the processor 114. The processor 114 is used for executing various instructions to implement various functions of the driving recorder 110. In actual implementation, the driving recorder 110 further includes a memory, a speed sensor, a GPS (Global Positioning System), a power supply line, and so on (not shown in FIG. 1), which will not elaborated in the present embodiment.

The terminal device 120 may be a mobile phone, a tablet computer, an electronic book reader, an MP3 (Moving Picture Experts Group Audio Layer III) player, an MP4 (Moving Picture Experts Group Audio Layer IV) player, a laptop, a desktop computer, and so on. The terminal device 120 includes a communication component. The meaning of the communication component in the terminal device 120 may refer to that of the communication component in the driving recorder 110, which will not be elaborated in the present embodiment.

The driving recorder 110 establishes a wireless communication connection with the terminal device 120 through their respective wireless communication components. Alternatively, the driving recorder 110 is connected to the terminal device 120 through their respective hardware communication interfaces.

In other optional embodiments, the driving recorder 110 may not be directly connected to the terminal device 120. Instead, the driving recorder 110 may be connected to the terminal device 120 through a server. Optionally, both the driving recorder 110 and the terminal device 120 are installed with a client application or software having a communication function. The server is a backend server for the client application. The driving recorder 110 registers a first user account in the client application, and the terminal device 120 registers a second user account in the client application. The server transfers data for the first user account and the second user account, thereby realizing the communication connection between the driving recorder 110 and the terminal device 120. In the embodiment, the server may be a server, a server cluster or a cloud computing center composed of a number of servers. The present embodiment will be described exemplarily with reference to the diagram shown in FIG. 1.

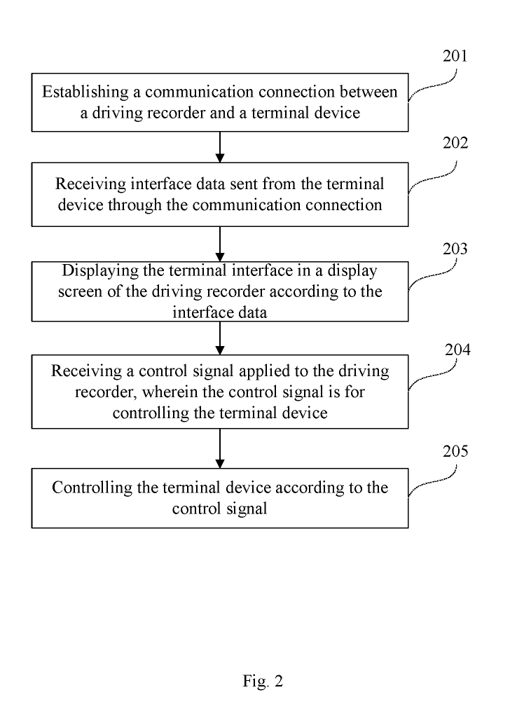

FIG. 2 is a flow chart of a display method provided by an embodiment of the present disclosure. The present embodiment is exemplified by applying the display method to the driving recorder shown in FIG. 1. The method includes following steps.

In step 201, a communication connection is established between the driving recorder and a terminal device.

In the embodiment, a distance between the terminal device and the driving recorder is less than a predetermined distance threshold, and the predetermined distance threshold is a system preset value or a user defined value. Optionally, the terminal device and the driving recorder are located in the same vehicle.

It should be noted that, in other embodiments, if the driving recorder and the terminal device are connected through a server, the distance between the terminal device and the driving recorder may be equal to or great than a predetermined distance threshold.

In step 202, interface data sent from the terminal device is received through the communication connection.

In the embodiment, the interface data is data of a terminal interface displayed by the terminal device in real time.

In step 203, the terminal interface is displayed in a display screen of the driving recorder according to the interface data.

In step 204, a control signal applied to the driving recorder is received, wherein the control signal is for controlling the terminal device.

In step 205, the terminal device is controlled according to the control signal.

To sum up, according to the display method provided by the embodiment of the present disclosure, after the driving recorder establishes a communication connection with a terminal device, interface data of the terminal device is received through the communication connection and displayed, thus displaying the terminal interface of the terminal device in a display screen of the driving recorder. The driving recorder may further receive a control operation and control the terminal device according to the control operation. Through the present disclosure, it solves a problem of high safety risk caused from a user operating his/her mobile phone when he or she driving. Since the user may directly view the message of the terminal device in the display screen of the driving recorder and perform appropriate operations during the driving process, without operating the terminal device, safety of driving is improved.

Optionally, in the above step 202, when the driving recorder receives the interface data sent from the terminal device, there are three different manners for receiving the data as follows.

The first manner: after establishing the communication connection with the terminal device, the driving recorder receives the interface data from the terminal device in real time.

Optionally, the terminal device automatically sends the interface data to the driving recorder after establishing the communication connection with the driving recorder; alternatively, the terminal device sends the interface data to the driving recorder when establishing a communication connection with the driving recorder and receiving a trigger operation. For example, after the terminal device establishes a communication connection with the driving recorder, a prompt message is displayed on the terminal device. The prompt message is used for prompting whether or not to send the interface data to the driving recorder. When receiving the trigger operation which allows the terminal device to send the interface data to the driving recorder, the terminal device starts to send the interface data to the driving recorder.

The second manner: after the driving recorder establishes a communication connection with the terminal device, when the terminal device receives a notification message, the driving recorder receives the interface data sent from the terminal device.

The third manner: when the driving recorder establishes a communication connection with the terminal device and a vehicle where the driving recorder is located is in a driving state, the driving recorder receives the interface data sent from the terminal device.

The second manner and the third manner will be described in detail in the following embodiments.

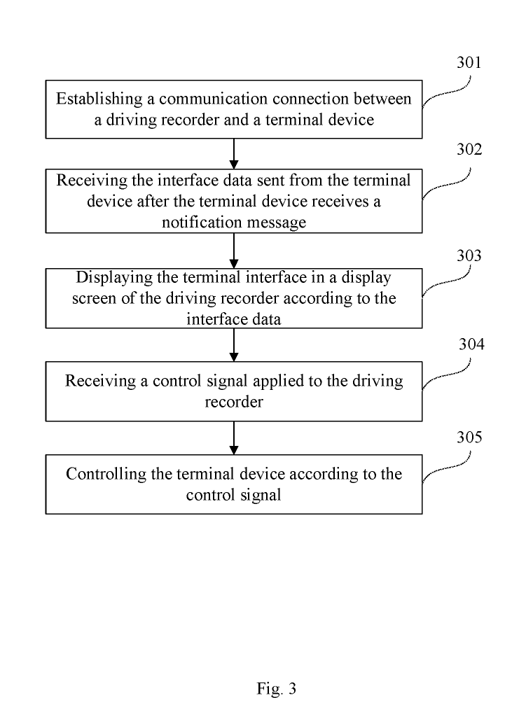

FIG. 3 is a flow chart of a display method provided by another embodiment of the present disclosure. In this embodiment, for example, the display method is applied in the driving recorder as shown in FIG. 1, and the driving recorder receives the interface data sent from the terminal device through the second manner. The method includes following steps.

In step 301, a communication connection is established between the driving recorder and a terminal device.

In step 302, after receiving a notification message, the terminal device receives the interface data sent from the terminal device.

In the present embodiment, the interface data is data of the terminal interface displayed by the terminal device after the terminal device receives the notification message. Optionally, the notification message includes an incoming call message, a short message or an instant messaging message in the terminal device. In general, when the notification message is an incoming call message, the terminal interface displayed by the terminal device after receiving the notification message is an incoming call interface; when the notification message is a message such as a short message or an instant messaging message, the terminal interface displayed by the terminal device after receiving the notification message is an interface including prompt information for prompting reception of a notification message. Optionally, the prompt information includes a name of the application program corresponding to the notification message, information of a sender who sends the notification message, breviary information of the notification message, and so on.

Optionally, the terminal device sends the interface data to the driving recorder at a predetermined time interval, and correspondingly, the driving recorder receives the interface data sent from the terminal device at the same predetermined time interval. Alternatively, when the terminal interface changes, the terminal device sends the interface data of the changed terminal interface to the driving recorder, and correspondingly, the driving recorder receives the interface data sent from the terminal device when the terminal interface of the terminal device changes.

Optionally, the terminal device sends the interface data of the entire terminal interface to the driving recorder, and correspondingly, the driving recorder receives the interface data of the entire terminal interface sent from the terminal device. Alternatively, the terminal device sends the interface data of the current terminal interface which is different from the last terminal interface to the driving recorder, and correspondingly, after the driving recorder receives the first interface data containing the entire terminal interface sent from the terminal device, it receives the interface data of the terminal interface sent from the terminal device which is different from the last terminal interface.

In step 303, the terminal interface is displayed in a display screen of the driving recorder according to the interface data.

Optionally, a corresponding relationship exists between pixel points of the display screen of the driving recorder and pixel points of the display screen of the terminal device. The corresponding relationship is a preset corresponding relationship, or it is a corresponding relationship obtained by the driving recorder through adaptive calculation. A pixel point in the display screen of the driving recorder is used to display the interface data of a pixel point in the terminal device corresponding to the pixel point in the display screen of the driving recorder. For example, if the pixel point at row 1 column 2 of the display screen of the driving recorder corresponds to the pixel point at row 1 column 4 of the display screen of the terminal device, and the display data of the pixel point at row 1 column 4 of the display screen of terminal device is data A, the data A is displayed in the position of the pixel point at row 1 column 2 after the driving recorder receives the interface data.

Optionally, the driving recorder displays the terminal interface in its display screen according to an aspect ratio of the display screen of the terminal device. For example, the display screen of the terminal device has a resolution of 800*480 and an aspect ratio of 5:3; and the display screen of the driving recorder has a resolution of 1280*720. Accordingly, the driving recorder displays what is shown in the display screen of the terminal device in an area of 1200*720, and the rest area of the display screen of the driving recorder may display a background color such as black.

In step 304, a control signal applied to the driving recorder is received.

In the embodiment, the control signal is used to control the terminal device. For example, the control signal is used to answer incoming calls to the terminal device. As another example, the control signal is used to view short messages sent to the terminal device.

Optionally, the control signal is a signal applied to a physical key of the driving recorder. Alternatively, the control signal is a touch signal applied to the display screen, which is a touch signal applied to the terminal interface displayed in the display screen.

In step 305, the terminal device is controlled according to the control signal.

Optionally, when the control signal is a signal applied to the physical key, the driving recorder determines an operation instruction corresponding to the physical key and sends the operation instruction to the terminal device, and the terminal device responds to the operation instruction.

When the control signal is a touch signal, the driving recorder determines a touch position of the touch signal, generates a corresponding operation instruction according to the touch position, sends the operation instruction to the terminal device, and the terminal device responds to the operation instruction. Alternatively, the driving recorder directly sends the touch position of the received touch signal applied to the terminal device, and the terminal device determines the operation instruction based on a position of the terminal device corresponding to the touch position and responds to the operation instruction.

To sum up, according to the display method provided by the embodiment of the present disclosure, after the driving recorder establishes a communication connection with a terminal device, interface data of the terminal device is received through the communication connection and displayed, thus displaying the terminal interface of the terminal device in a display screen of the driving recorder. The driving recorder may further receive a control operation and control the terminal device according to the control operation. Through the present disclosure, it solves a problem of high safety risk caused from a user operating his/her mobile phone when he or she is driving. Since the user may directly view the message sent to the terminal device in the display screen of the driving recorder and perform appropriate operations during the driving process, without operating the terminal device, safety of driving is improved.

According to the display method provided by the embodiment of the present disclosure, the display screen of the driving recorder may display the display interface of other terminal devices, which enriches display contents of the display screen of the driving recorder, and improves the utilization ratio of the display screen of the driving recorder.

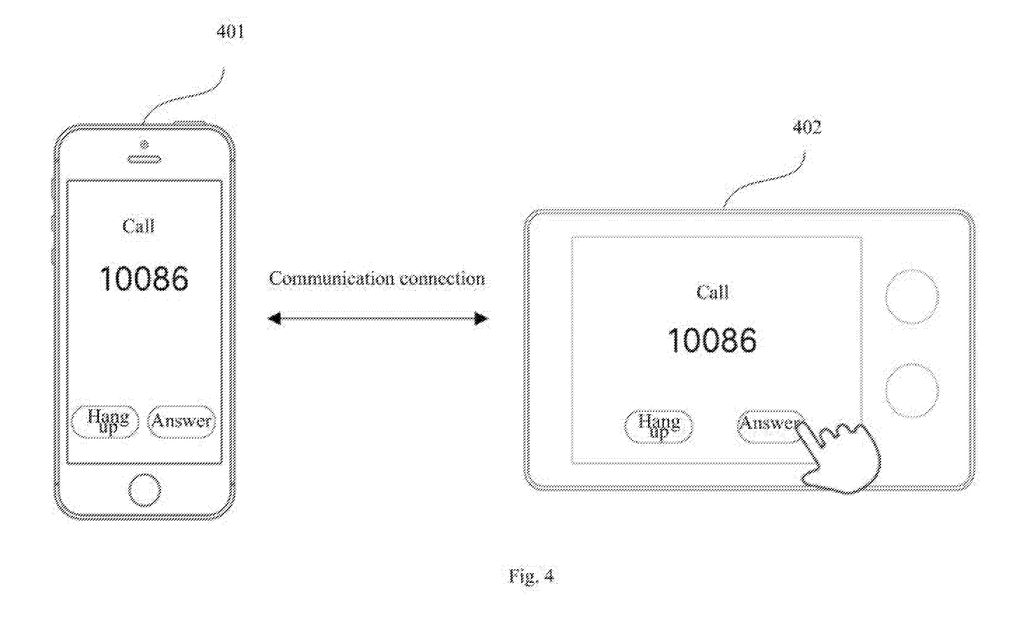

In an exemplary example, as shown in FIG. 4, after the driving recorder establishes a connection with the terminal device, when the terminal device receives an incoming call, the terminal device displays a display interface 401, and at that time, when the driving recorder receives the interface data and the interface data is displayed, the driving recorder displays a display interface 402.

When the user clicks “answer” in the screen of the driving recorder, the terminal device answers the incoming call. At that time, the user may transmit audio through components such as a microphone and handset of the driving recorder, to make a call.

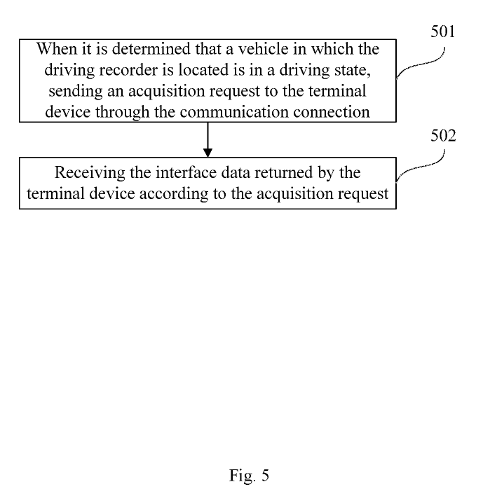

Optionally, when the driving recorder receives the interface data sent from the terminal device through the third manner described above, the above step 302 includes following two steps, as shown in FIG. 5.

In step 501, when it is determined that the vehicle where the driving recorder is positioned is in a driving state, an acquisition request is sent to the terminal device through the communication connection.

Optionally, the driving recorder determines the driving state of the vehicle when a speed sensor determines that the travel speed of the vehicle is greater than 0, and/or, the driving recorder determines the driving state of the vehicle when a GPS mounted on the vehicle determines that a current position of the vehicle has changed, and/or, the driving recorder determines the driving state of the vehicle when an image acquired by the data acquisition component has moved.

In step 502, the interface data returned by the terminal device according to the acquisition request is received.

Optionally, in other optional embodiments, when the driving recorder receives the interface data sent from the terminal device by any one of the above three manners, in the above step 303, when the driving recorder displays the terminal interface in the display screen according to the interface data, there are three different implementations.

The first mode: the driving recorder displays the acquired driving data and the interface data from the terminal device in its display screen at the same time.

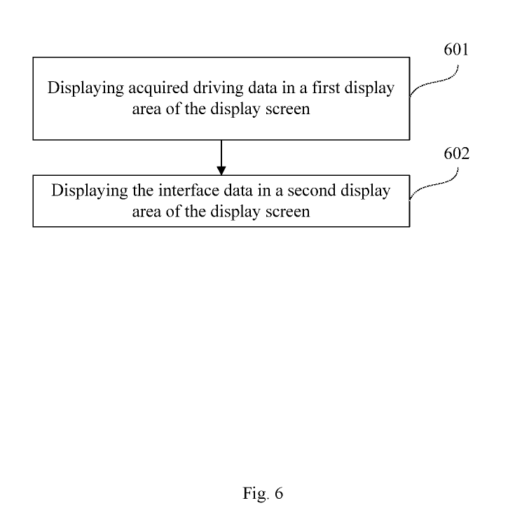

Optionally, the above step 303 includes following two steps, as shown in FIG. 6.

In step 601, the acquired driving data is displayed in a first display area of the display screen of the driving recorder.

In step 602, the interface data is displayed in a second display area of the display screen of the driving recorder.

In the embodiment, the first display area and the second display area do not overlap with each other.

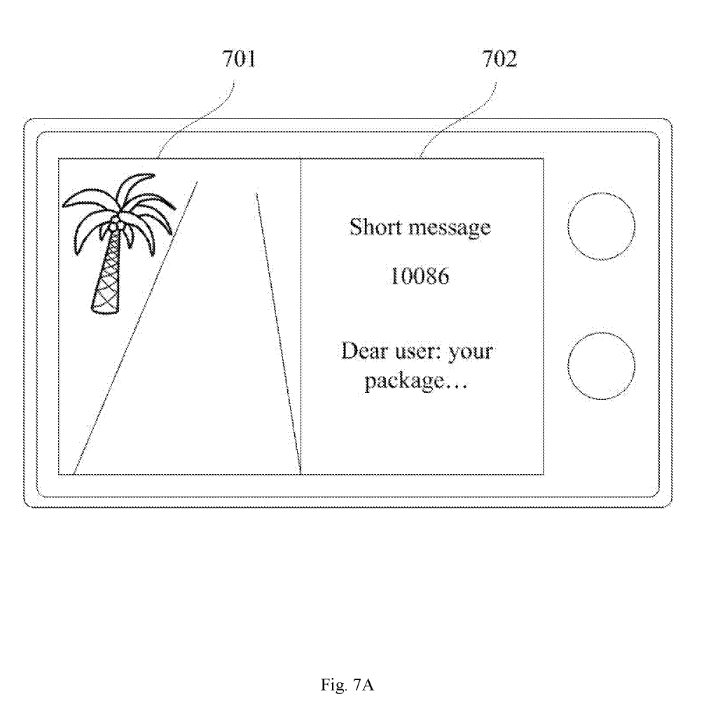

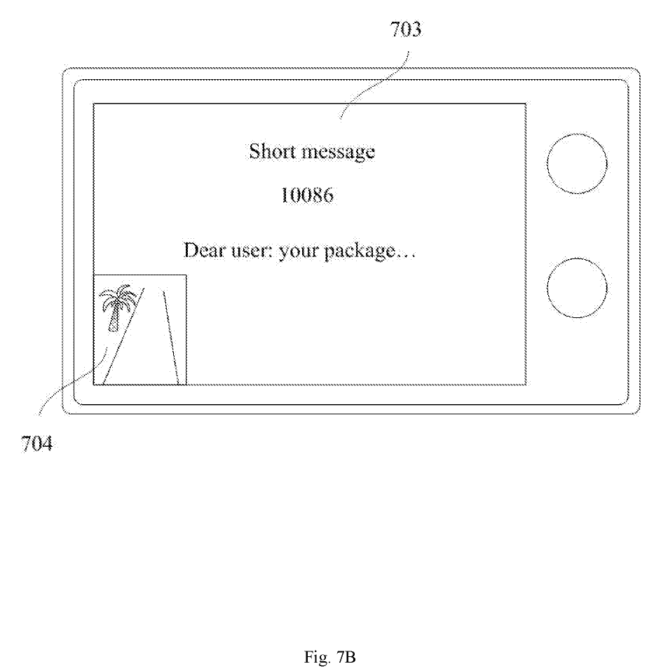

Optionally, sizes of the first display area and the second display area are the same. The first display area and the second display area are displayed side by side, either horizontally or vertically, in the display screen. FIG. 7A is a schematic diagram of the display of the display screen of the driving recorder. The first display area 701 of the display screen displays the driving data, and the second display area 702 displays the interface data of the terminal device.

Optionally, the first display area occupies a display space larger than the second display area; alternatively, the second display area occupies a display space larger than the first display area. For example, FIG. 7B shows a schematic diagram of the display of the display screen of the driving recorder. The second display area 703 occupies a display space larger than the first display area 704.

Sizes of the first display area and the second display area may be preset by the user or the system, and this embodiment is not limited thereto.

The second mode: the driving recorder displays the driving data in the display screen, and it switches to display the interface data upon the reception of the interface data.

Optionally, the step 303 may be implemented as: if the interface data is received during displaying of the acquired driving data, switching to display at least the interface data in the display screen.

Optionally, if, in the process of displaying the acquired driving data, the driving recorder receives the interface data of the terminal interface displayed by the terminal device after the terminal device receives a notification message, the driving recorder switches to display the interface data, i.e., the driving recorder switches to display the terminal interface displayed by the terminal device after the terminal device receives a notification message.

Optionally, if the terminal device sends the interface data to the driving recorder upon the receipt of the notification message, the driving recorder switches to display the interface data just upon the receipt of the interface data.

Optionally, if the terminal device sends the interface data to the driving recorder no matter whether the notification message is received or not, the driving recorder determines whether or not the interface data of the notification message is included when the interface data is received. When it is determined that the interface data of the notification message is included, the driving recorder switches to display the interface data.

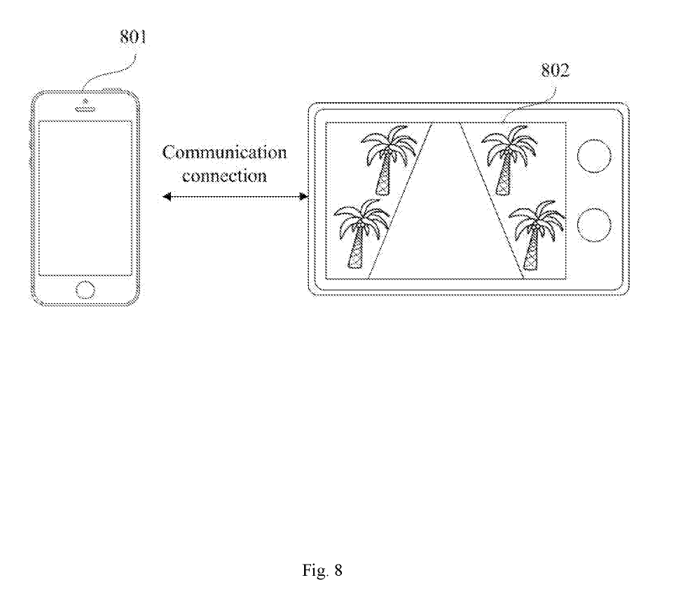

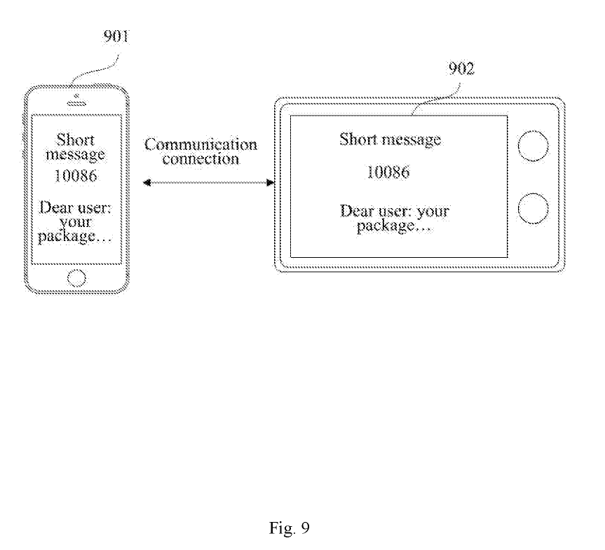

In an exemplary example, as shown in FIG. 8, it is assumed that the terminal device sends the interface data to the driving recorder upon receiving the notification message, the terminal device displays a display interface 801 when the notification message is not received, and at that time the display screen of the driving recorder displays the driving data as shown in a display interface 802. When the terminal device receives a short message, it is assumed that, the terminal device displays a display interface 901, the driving recorder switches to display the interface data, and the display screen of the driving recorder displays a display interface 902, as shown in FIG. 9.

The third mode: the driving recorder switches between the display of the interface data and the display of the driving data according to the received switching operation.

Optionally, the above step 303 may be implemented as: if a switching operation is received during displaying of the acquired driving data, switching to display at least the interface data in the display screen according to the switching operation.

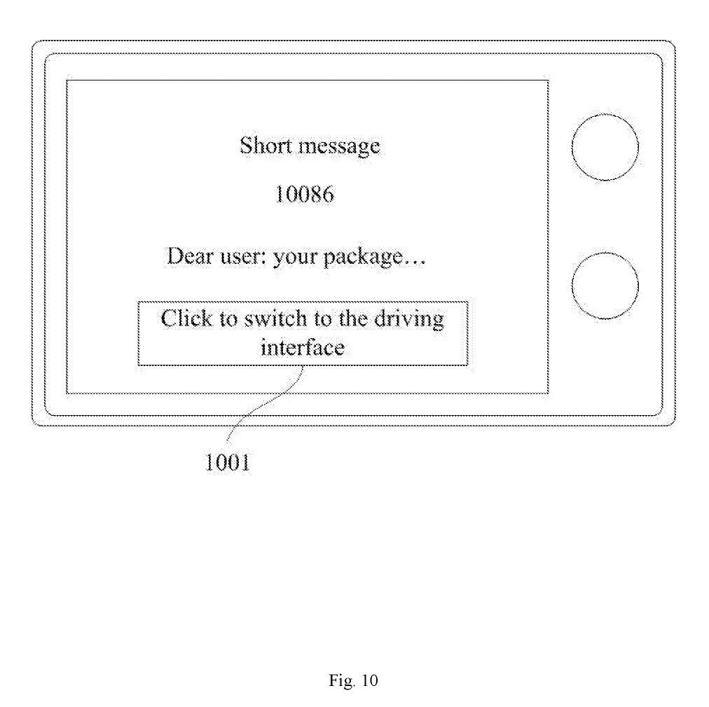

Optionally, the driving recorder displays a first entry in the display screen when displaying the interface data. The first entry is typically a virtual key which is used to switch the display screen to display the driving data when the driving recorder determines that a switching operation is applied to the first entry. In other optional embodiments, the switching operation may also be applied to a physical key of the driving recorder, which is not limited in the present embodiment. As shown in FIG. 10, the driving recorder displays the first entry 1001 when displaying the interface data in the display screen, and the first entry 1001 further displays a prompt text or image for prompting the function of the first entry.

Optionally, the driving recorder displays a second entry in the display interface when displaying the driving data. When the driving recorder determines that a switching operation is acting on the second entry, it switches to display the interface data.

The following is embodiments of apparatuses according to the present disclosure, which may be configured to perform the methods of the embodiments of the present disclosure. Details not disclosed in the embodiments of apparatuses may be referred to the embodiments of methods of the present disclosure.

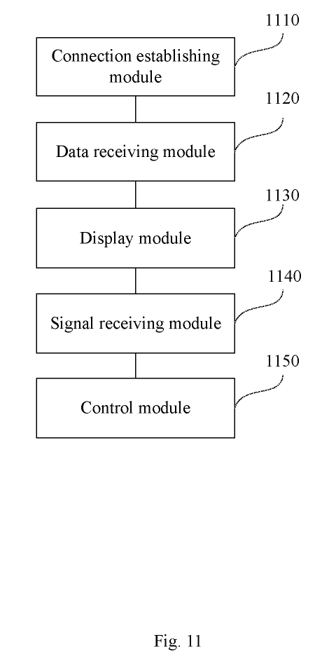

FIG. 11 is a block diagram of a display apparatus provided by an exemplary embodiment of the present disclosure. The apparatus may be implemented as a part of or the entire driving recorder shown in FIG. 1 by hardware, software, or a combination of both. The apparatus includes but not limited to:

a connection establishing module 1110, configured to establish a communication connection between the driving recorder and a terminal device, wherein a distance between the terminal device and the driving recorder is less than a predetermined distance threshold;

a data receiving module 1120, configured to receive interface data sent from the terminal device through the communication connection, wherein the interface data is data of a terminal interface displayed by the terminal device in real time;

a display module 1130, configured to display the terminal interface in a display screen of the driving recorder according to the interface data;

a signal receiving module 1140, configured to receive a control signal applied to the driving recorder, wherein the control signal is for controlling the terminal device; and

a control module 1150, configured to control the terminal device according to the control signal.

To sum up, according to the display apparatus provided by the embodiment of the present disclosure, after the driving recorder establishes a communication connection with a terminal device, interface data of the terminal device is received through the communication connection and displayed, thus displaying the terminal interface of the terminal device in a display screen of the driving recorder. The driving recorder may further receive a control operation and control the terminal device according to the control operation. Through the present disclosure, it solves a problem of high safety risk caused from a user operating his/her mobile phone when he or she is driving. Since the user may directly view the message of the terminal device in the display screen of the driving recorder and perform appropriate operations during the driving process, without operating the terminal device, safety of driving is improved.

Optionally, the above data receiving module 1120 is further configured to: receive the interface data sent from the terminal device after the terminal device receives a notification message, wherein the interface data is data of the terminal interface displayed by the terminal device after the terminal device receives the notification message.

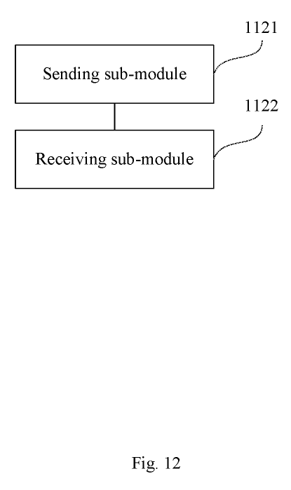

Optionally, the above data receiving module 1120 includes following sub-modules, as shown in FIG. 12:

a sending sub-module 1121, configured to, when it is determined that a vehicle in which the driving recorder is located is in a driving state, send an acquisition request to the terminal device through the communication connection; and

a receiving sub-module 1122, configured to receive the interface data returned by the terminal device according to the acquisition request.

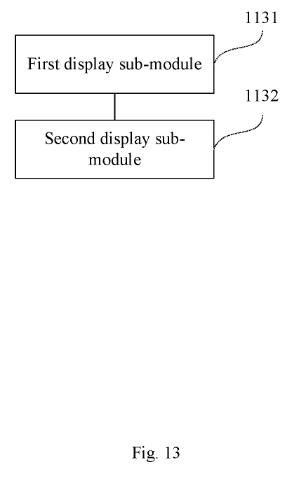

Optionally, the above data display module 1130 includes following sub-modules, as shown in FIG. 13:

a first display sub-module 1131, configured to display acquired driving data in a first display area of the display screen; and

a second display sub-module 1132, configured to display the interface data in a second display area of the display screen,

wherein the first display area and the second display area do not overlap with each other.

Optionally, the above display module 1130 is further configured to: if the interface data is received during displaying of the acquired driving data, switch to display at least the interface data in the display screen.

Optionally, the above display module 1130 is further configured to: if a switching operation is received during displaying of the acquired driving data, switch to display at least the interface data in the display screen according to the switching operation.

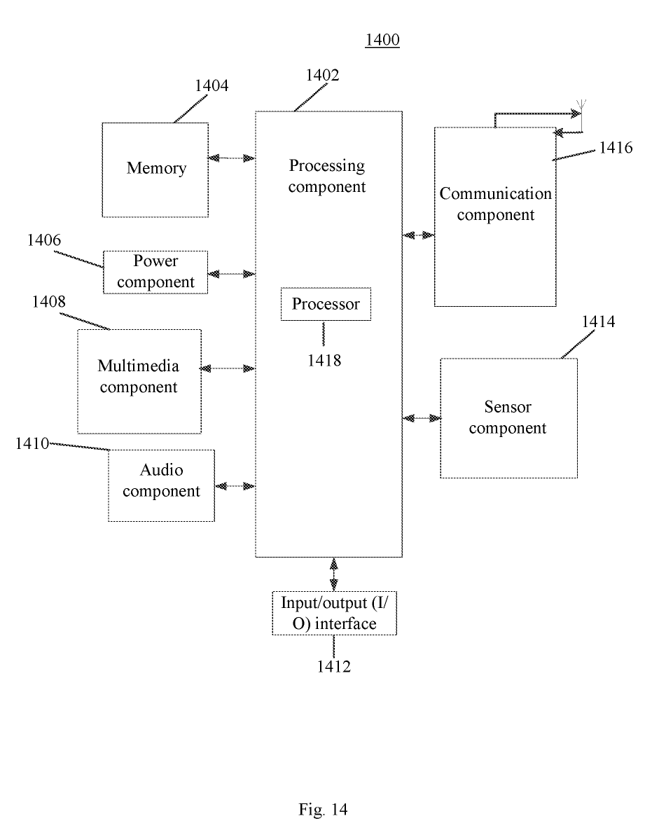

FIG. 14 is a structural schematic diagram of a driving recorder provided by an exemplary embodiment. Referring to FIG. 14, the apparatus 1400 may include one or more of the following components: a processing component 1402, a memory 1404, a power component 1406, a multimedia component 1408, an audio component 1410, an input/output (I/O) interface 1412, a sensor component 1414, and a communication component 1416.

The processing component 1402 typically controls overall operations of the apparatus 1400, such as the operations associated with display, telephone calls, data communications, camera operations and recording operations. The processing component 1402 may include one or more processors 1418 to execute instructions to perform all or part of the steps in the above described methods. Moreover, the processing component 1402 may include one or more modules which may facilitate the interaction between the processing component 1402 and other components. For instance, the processing component 1402 may include a multimedia module to facilitate the interaction between the multimedia component 1408 and the processing component 1402.

The memory 1404 is configured to store various types of data to support the operations of the apparatus 1400. Examples of such data include instructions for any applications or methods operated on the apparatus 1400, contact data, phonebook data, messages, pictures, video, etc. The memory 1404 may be implemented by using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1406 provides power to various components of the apparatus 1400. The power component 1406 may include a power management system, one or more power sources, and any other components associated with the generation, management, and distribution of power in the apparatus 1400.

The multimedia component 1408 includes a screen providing an output interface between the apparatus 1400 and the user. In embodiments, the screen may include a liquid crystal display (LCD) and a touch panel (TP). If the screen includes the touch panel, the screen may be implemented as a touch display screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In an embodiment, the multimedia component 1408 includes a front camera and/or a rear camera. The front camera and the rear camera may receive an external multimedia datum while the apparatus 1400 is in an operation mode, such as a photographing mode or a video mode. Each of the front camera and the rear camera may be a fixed optical lens system or have focus and optical zoom capability.

The audio component 1410 is configured to output and/or input audio signals. For example, the audio component 1410 includes a microphone (“MIC”) configured to receive an external audio signal when the apparatus 1400 is in an operation mode, such as a call mode, a recording mode, and a voice recognition mode. The received audio signal may be further stored in the memory 1404 or sent via the communication component 1416. In embodiments, the audio component 1410 further includes a speaker to output audio signals.

The I/O interface 1412 provides an interface between the processing component 1402 and peripheral interface modules, such as a keyboard, a click wheel, buttons, and the like. The buttons may include, but are not limited to, a home button, a volume button, a starting button, and a locking button.

The sensor component 1414 includes one or more sensors to provide state assessments of various aspects of the apparatus 1400. For instance, the sensor component 1414 may detect an open/closed state of the apparatus 1400, relative positioning of components, e.g., the display and the keypad, of the apparatus 1400, a change in position of the apparatus 1400 or a component of the apparatus 1400, a presence or absence of user contact with the apparatus 1400, an orientation or an acceleration/deceleration of the apparatus 1400, and a change in temperature of the apparatus 1400. The sensor component 1414 may include a proximity sensor configured to detect the presence of nearby objects without any physical contact. The sensor component 1414 may further include a light sensor, such as a CMOS or CCD image sensor, for use in imaging applications. In embodiments, the sensor component 1414 may further include an accelerometer sensor, a gyroscope sensor, a magnetic sensor, a pressure sensor or a temperature sensor.

The communication component 1416 is configured to facilitate communication, wired or wirelessly, between the apparatus 1400 and other apparatuses. The apparatus 1400 may access a wireless network based on a communication standard, such as WiFi, 2G or 3G or a combination thereof. In one exemplary embodiment, the communication component 1416 receives a broadcast signal or broadcast associated information from an external broadcast management system via a broadcast channel. In one exemplary embodiment, the communication component 1416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 1400 may be implemented with one or more application specific integrated circuits (ASICs), digital signal processors (DSPs), digital signal processing apparatuses (DSPDs), programmable logic apparatuses (PLDs), field programmable gate arrays (FPGAs), controllers, micro-controllers, microprocessors, or other electronic components, for performing the above method such as panorama shooting method.

In exemplary embodiments, there is further provided a non-transitory computer-readable storage medium including instructions, such as included in the memory 1404, executable by the processor 1418 in the apparatus 1400, for performing the above-described methods for synchronizing states. For example, the non-transitory computer-readable storage medium may be a ROM, a RAM, a CD-ROM, a magnetic tape, a floppy disc, an optical data storage apparatus, and the like.

Other embodiments of the disclosure may be apparent to those skilled in the art from consideration of the specification and practice of the disclosure disclosed here. This application is intended to cover any variations, uses, or adoptions of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A display method for use in a driving recorder, comprising:
establishing a communication connection between the driving recorder and a terminal device;
receiving interface data sent from the terminal device through the communication connection, wherein the interface data is data of a terminal interface displayed by the terminal device in real time;
displaying the terminal interface in a display screen of the driving recorder according to the interface data;
receiving a control signal applied to the driving recorder, wherein the control signal is for controlling the terminal device; and
controlling the terminal device according to the control signal.

2. The method according to claim 1, wherein the receiving interface data sent from the terminal device through the communication connection comprises:
receiving the interface data sent from the terminal device after the terminal device receives a notification message, wherein the interface data is data of the terminal interface displayed by the terminal device after the terminal device receives the notification message.

3. The method according to claim 1, wherein the receiving interface data sent from the terminal device through the communication connection comprises:
when it is determined that a vehicle in which the driving recorder is located is in a driving state, sending an acquisition request to the terminal device through the communication connection; and
receiving the interface data returned by the terminal device according to the acquisition request.

4. The method according to claim 1, wherein the displaying the terminal interface in a display screen of the driving recorder according to the interface data comprises: displaying acquired driving data in a first display area of the display screen; and
displaying the interface data in a second display area of the display screen, wherein the first display area and the second display area do not overlap with each other.

5. The method according to claim 2, wherein the displaying the terminal interface in a display screen of the driving recorder according to the interface data comprises:
displaying acquired driving data in a first display area of the display screen; and
displaying the interface data in a second display area of the display screen,
wherein the first display area and the second display area do not overlap with each other.

6. The method according claim 1, wherein the displaying the terminal interface in a display screen of the driving recorder according to the interface data comprises:
if the interface data is received during displaying of acquired driving data in the display screen, switching to display at least the interface data in the display screen.

7. The method according to claim 2, wherein the displaying the terminal interface in a display screen of the driving recorder according to the interface data comprises:
if the interface data is received during displaying of acquired driving data in the display screen, switching to display at least the interface data in the display screen.

8. The method according to claim 1, wherein the displaying the terminal interface in a display screen of the driving recorder according to the interface data comprises:
if a switching operation is received during displaying of acquired driving data in the display screen, switching to display at least the interface data in the display screen according to the switching operation.

9. The method according to claim 2, wherein the displaying the terminal interface in a display screen of the driving recorder according to the interface data comprises:
if a switching operation is received during displaying of acquired driving data in the display screen, switching to display at least the interface data in the display screen according to the switching operation.

10. The method according to claim 1, wherein a distance between the terminal device and the driving recorder is less than a predetermined distance threshold.

11. A display apparatus for use in a driving recorder, comprising:
a processor; and
a memory for storing instructions executable by the processor,
wherein the processor is configured to:
establish a communication connection between the driving recorder and a terminal device;
receive interface data sent from the terminal device through the communication connection, wherein the interface data is data of a terminal interface displayed by the terminal device in real time;
display the terminal interface in a display screen of the driving recorder according to the interface data;
receive a control signal applied to the driving recorder, wherein the control signal is for controlling the terminal device; and
control the terminal device according to the control signal.

12. The apparatus according to claim 11, wherein the processor is further configured to:
receive the interface data sent from the terminal device after the terminal device receives a notification message, wherein the interface data is data of the terminal interface displayed by the terminal device after the terminal device receives the notification message; or
when it is determined that a vehicle in which the driving recorder is located is in a driving state, send an acquisition request to the terminal device through the communication connection; and
receive the interface data returned by the terminal device according to the acquisition request.

13. The apparatus according to claim 11, wherein the processor is further configured to:
display acquired driving data in a first display area of the display screen; and
display the interface data in a second display area of the display screen,
wherein the first display area and the second display area do not overlap with each other.

14. The apparatus according to claim 12, wherein the processor is further configured to:
display acquired driving data in a first display area of the display screen; and
display the interface data in a second display area of the display screen,
wherein the first display area and the second display area do not overlap with each other.

15. The apparatus according to claim 11, wherein the processor is further configured to:
if the interface data is received during displaying of acquired driving data in the display screen, switch to display at least the interface data in the display screen.

16. The apparatus according to claim 12, wherein the processor is further configured to:
if the interface data is received during displaying of acquired driving data in the display screen, switch to display at least the interface data in the display screen.

17. The apparatus according to claim 11, wherein the processor is further configured to:
if a switching operation is received during displaying of acquired driving data in the display screen, switch to display at least the interface data in the display screen according to the switching operation.

18. The apparatus according to claim 12, wherein the processor is further configured to:
if a switching operation is received during displaying of acquired driving data in the display screen, switch to display at least the interface data in the display screen according to the switching operation.

19. The apparatus according to claim 11, wherein a distance between the terminal device and the driving recorder is less than a predetermined distance threshold.

20. A driving recorder, comprising: a display screen, a processor and a memory for storing instructions executable by the processor, wherein the display screen is electrically connected to the processor, and the processor is configured to perform:
establishing a communication connection with a terminal device, wherein a distance between the terminal device and the driving recorder is less than a predetermined distance threshold;
receiving interface data sent from the terminal device through the communication connection, wherein the interface data is data of a terminal interface displayed by the terminal device in real time;
displaying the terminal interface in a display screen of the driving recorder according to the interface data;
receiving a control signal applied to the driving recorder, wherein the control signal is for controlling the terminal device; and
controlling the terminal device according to the control signal.
